(19) United States
(12) Patent Application Publication
(10) Pub. No.: US 2024/0310040 A1
(43) Pub. Date: Sep. 19, 2024

(54) INLET NOZZLE ASSEMBLY

(71) Applicant: Edwards Limited, Burgess Hill, Sussex (GB)

(72) Inventors: Andrew James Seeley, Clevedon, Somerset (GB); Ian David Benzeval, Clevedon, Somerset (GB)

(21) Appl. No.: 18/576,592

(22) PCT Filed: Jul. 7, 2022
(86) PCT No.: PCT/GB2022/051746

§ 371 Date: Jan. 4, 2024

(30) Foreign Application Priority Data
Jul. 13, 2021 (GB) 20110049.0

(51) Int. Cl. F23G 7/06; B01D 53/70; F23D 14/48

(52) U.S. Cl. CPC F23G 7/06; F23D 14/48; B01D 53/70; B01D 2257/2066; B01D 2258/0216; F23G 2209/142

(57) ABSTRACT

An inlet nozzle assembly includes: a delivery nozzle configured to deliver an effluent stream into an abatement chamber; and a mount configured to couple with an enclosure defining the abatement chamber, the mount being further configured to receive the delivery nozzle, wherein the delivery nozzle is configured to extend from the mount distal from the abatement chamber. In this way, the height of the mount and the location of the abatement chamber can remain fixed for different length delivery nozzles and different amounts of the delivery nozzle extend from the mount, dependent on the length of that nozzle.

### CROSS-REFERENCE OF RELATED APPLICATION

This application is a Section 371 National Stage Application of International Application No. PCT/GB2022/051746, filed Jul. 7, 2022, and published as WO 2023/285780A1 on Jan. 19, 2023, the content of which is hereby incorporated by reference in its entirety and which claims priority of British Application No. 2110049.0, filed Jul. 13, 2021.

### FIELD

The field of the invention relates to an inlet nozzle assembly, an abatement apparatus and a method.

### BACKGROUND

Abatement apparatus, such as radiant burners or other types of abatement apparatus, are known and are typically used for treating an effluent gas stream from a manufacturing processing tool used in, for example, the semiconductor or flat panel display manufacturing industry. During such manufacturing, residual perfluorinated compounds (PFCs) and other compounds exist in the effluent gas stream pumped from the process tool. PFCs are difficult to remove from the effluent gas and their release into the environment is undesirable because they are known to have relatively high greenhouse activity.

Known radiant burners use combustion to remove the PFCs and other compounds from the effluent gas stream, such as that described in EP 0 694 735. Typically, the effluent gas stream is a nitrogen stream containing PFCs and other compounds. The effluent stream is conveyed into a combustion chamber that is laterally surrounded by the exit surface of a foraminous gas burner. In some cases treatment materials, such as fuel gas, can be mixed with the effluent gas stream before entering the combustion chamber. Fuel gas and air are simultaneously supplied to the foraminous burner to affect combustion at the exit surface. The products of combustion from the foraminous burner react with the effluent stream mixture to combust compounds in the effluent stream.

Although arrangements of abatement apparatus exist, they each have their own shortcomings. Accordingly, it is desired to provide an improved arrangement for abatement apparatus.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an inlet nozzle assembly for an abatement apparatus for treating an effluent stream from a semiconductor processing tool, the inlet nozzle assembly comprising: a delivery nozzle configured to deliver the effluent stream into an abatement chamber; and a mount configured to couple with an enclosure defining the abatement chamber, the mount being further configured to receive the delivery nozzle for delivery of the effluent stream into the abatement chamber, wherein the delivery nozzle is configured to extend from the mount distal from the abatement chamber.

The first aspect recognizes that a problem with abatement apparatus is that each combustion chamber needs to be carefully configured to suit the effluent stream flow rates and types to ensure adequate abatement. This means that a variety of, often bespoke, parts are required to be produced in order to provide an abatement apparatus suitable to be operated under a variety of different conditions. For example, the length of the delivery nozzle which delivers the effluent stream into the abatement chamber can vary, depending on the effluent stream and/or its flow rate. Having differing length delivery nozzles can be problematic since this can impact on the size of the plate or mount which receives the delivery nozzle, as well as the location of the combustion chamber within the abatement apparatus with consequential impact on the sizing of related parts or components. This can lead to requiring different height plates or mounts, different height housings for the combustion chamber and other related parts, which increases the inventory of parts required to produce and maintain such abatement apparatus.

Accordingly, an inlet nozzle assembly is provided. The inlet nozzle assembly may be for an abatement apparatus. The abatement apparatus may treat an effluent stream from a semiconductor processing tool. The inlet nozzle assembly may comprise a delivery nozzle. The delivery nozzle may deliver the effluent stream into an abatement chamber. The inlet nozzle assembly may comprise a mount or plate. The mount may be configured to couple with, retain or support the abatement chamber. The mount may be configured to receive the delivery nozzle to deliver the effluent stream into the abatement chamber. The delivery nozzle may be configured to extend from the mount distal from or in a direction away from the abatement chamber. In this way, rather than the height of the mount or the location of the abatement chamber needing to change for different length delivery nozzles, instead the height of the mount and the location of the abatement chamber can remain fixed for different length delivery nozzles and different amounts of the delivery nozzle extend from the mount, dependent on the length of that nozzle. This helps to reduce the inventory of since different mounts, housings and other related parts are no longer required for different length delivery nozzles, which reduces the inventory of these different parts.

The mount may comprise at least part of a head plate.

The mount may define a receiving aperture configured to receive the delivery nozzle. Hence, the delivery nozzle may extend through an aperture in the mount.

The delivery nozzle may be dimensioned to extend from a surface of the mount distal from the abatement chamber. Hence, the delivery nozzle may extend above an upstream surface of the mount which faces away from the abatement chamber.

The delivery nozzle may be dimensioned to upstand from the surface of the mount.

The mount may have a downstream surface which couples with or receives the enclosure defining the abatement chamber. The mount may also have an upstream surface from which the delivery nozzle extends.

The delivery nozzle may comprise an upstream inlet portion which defines an inlet chamber which receives the effluent stream. The delivery nozzle may also comprise a downstream delivery portion which defines a delivery chamber which delivers the effluent stream into the abatement chamber. At least a part or portion of the delivery portion may be dimensioned to extend from the mount.

The inlet portion may be configured to couple with or connect to a supply of the effluent stream. Hence, the inlet portion may be provided with a coupling which couples with a supply such as a pipe which supplies the effluent stream to the inlet portion.

The inlet portion may be configured to transition from a cross-sectional shape of the supply of the effluent stream to a cross-sectional shape of the delivery portion. The transition may be a lofted transition.

At least a part or portion of the delivery portion may be dimensioned to upstand from the upstream surface.

The mount may be configured to receive a remainder or residual length of the delivery portion therewithin. That is to say, the portion of the delivery portion which does not extend from the upstream surface is received within the mount. The remainder may also extend at least partially from the mount into the abatement chamber.

The delivery portion may be dimensioned to extend or protrude from upstream of the upstream surface to the abatement chamber.

The delivery nozzle may comprise a dividing plate. The dividing plate may define an aperture. The aperture may couple the inlet chamber with the delivery chamber. The delivery nozzle may be dimensioned to locate the dividing plate upstream of the upstream surface of the mount.

The delivery nozzle may comprise an upstream body. The upstream body may comprise the inlet portion and at least a part of the delivery portion. The delivery nozzle may comprise a downstream body. The downstream body may comprise a remainder of the delivery portion. Hence, the delivery nozzle can be made from two bodies or components. The downstream body may be of a fixed length to extend through the mount and into the abatement chamber. The upstream body may be of a variable length, depending on the overall length required for the delivery nozzle.

The downstream body may be dimensioned to extend from the upstream surface. The downstream body may extend through the mount and the enclosure to the abatement chamber. This enables the downstream body to be of a standard length, which helps to reduce the inventory of parts.

The upstream body may be dimensioned to provide one of a plurality of different lengths of the at least part of the delivery portion. Accordingly, different length upstream bodies may be provided, depending on the overall lengths required from the delivery nozzle.

The upstream body may be dimensioned to provide a combined length of the delivery portion which delivers a developed or selected flow profile of the effluent stream into the abatement chamber. Accordingly, the delivery nozzle is dimensioned to have an overall length which provides the required type of flow of the effluent stream into the abatement chamber.

The upstream body may be dimensioned to provide a combined length of the delivery portion which avoids or prevents backflow of the effluent stream from the abatement chamber into the delivery nozzle.

The inlet nozzle may comprise a discontinuity shaped to separate the effluent stream into a least a pair of vortices and the upstream body may be dimensioned to provide a length of the delivery portion which prevents the pair of vortices from extending into the abatement chamber. Hence, where the effluent stream has been formed into at least a pair of vortices, typically by a discontinuity such as an annular plate or the like, the combined length of the delivery portion provided by the upstream body and the downstream body may be selected to be longer than the length of those vortices. If the vortices were to extend into the combustion chamber then this can result in lower-pressure areas which can cause gases from within the abatement chamber to be drawn back into the delivery nozzle which can result in accumulation of particulates within the delivery nozzle, leading to blockages. In other words, the combined length may be selected so that the vortices fail to extend from the delivery nozzle. This results in a higher velocity split (swallow-tail-like) turbulent flow effluent stream (as described in GB2550382, the contents of which are incorporated in their entirety by reference) that enters the abatement chamber and that higher velocity split effluent stream exhibits greater than a threshold amount of shear mixing as it enters the abatement chamber which improves the destruction rate efficiency.

The upstream body may be formed of a material having a lower use temperature and/or a lower oxidation resistance than material forming the downstream body.

The upstream body may be formed of material which is chemically compatible with the effluent stream. The downstream body may be formed of material which is chemically compatible with abatement by-products. By providing separate upstream and downstream bodies, suitable materials can be used for both parts.

The inlet nozzle may have an obround cross-section.

The aperture may have an obround cross-section.

The aperture may be located symmetrically within the inlet nozzle.

According to a second aspect, there is provided an abatement apparatus comprising at least one inlet nozzle assembly of the first aspect.

The abatement apparatus may comprise a plurality of the inlet nozzle assemblies, each having a having a different length.

The abatement apparatus may comprise the features of the inlet nozzle assembly set out above.

According to a third aspect, there is provided a method comprising: configuring a delivery nozzle to deliver an effluent stream into an abatement chamber; coupling a mount with an enclosure defining the abatement chamber; and receiving the delivery nozzle with the mount, the delivery nozzle extending from the mount distal from the abatement chamber.

The method may comprise providing the mount as at least a part of a headplate.

The method may comprise receiving the delivery nozzle in a receiving aperture of the mount.

The method may comprise dimensioning the delivery nozzle to extend from a surface of the mount distal from the abatement chamber.

The method may comprise dimensioning the delivery nozzle to upstand from the surface of the mount.

The method may comprise coupling the enclosure with has a downstream surface of the mount and extending the foraminous sleeve from an upstream surface of the mount.

The method may comprise forming the delivery nozzle from an upstream inlet portion defining an inlet chamber for receiving the effluent stream and a downstream delivery portion defining a delivery chamber for delivery of the effluent stream into the abatement chamber, and dimensioning at least a part of the delivery portion to extend from the mount.

The method may comprise coupling the inlet portion with a supply of the effluent stream.

The method may comprise dimensioning at least a part of the delivery portion to upstand from the upstream surface.

The method may comprise configuring the mount to receive at least a portion of a remainder of the delivery portion therewithin.

The method may comprise dimensioning the delivery portion to extend from upstream of the upstream surface to the abatement chamber.

The method may comprise providing the delivery nozzle with a dividing plate defining an aperture which couples the inlet chamber with the delivery chamber and dimensioning the delivery nozzle to locate the dividing plate upstream of the upstream surface of the mount.

The method may comprise providing the delivery nozzle with an upstream body comprising the inlet portion and the at least a part of the delivery portion and a downstream body comprising a remainder of the delivery portion.

The method may comprise dimensioning the downstream body to extend from the upstream surface, through the mount and the sleeve to the abatement chamber.

The method may comprise dimensioning the upstream body to provide one of a plurality of different lengths of the at least a part of the delivery portion.

The method may comprise dimensioning the upstream body to provide a combined length of the delivery portion which delivers a developed selected flow profile of the effluent stream into the abatement chamber.

The method may comprise dimensioning the upstream body to provide a combined length of the delivery portion which delivers avoids backflow of the effluent stream from the abatement chamber.

The method may comprise separating the effluent stream into a pair of vortices and dimensioning the upstream body to provide a length of the delivery portion which prevents the pair of vortices from extending into the abatement chamber. Hence, where the effluent stream has been formed into at least a pair of vortices, typically by a discontinuity such as an annular plate or the like, the combined length of the delivery portion provided by the upstream body and the downstream body If the vortices were to extend into the combustion chamber then this can result in lower-pressure areas which can cause gases from within the abatement chamber to be drawn back into the delivery nozzle which can result in accumulation of particulates within the delivery nozzle, leading to blockages. In other words, the combined length may be selected so that the vortices fail to extend from the delivery nozzle. This results in a higher velocity split effluent stream that enters the abatement chamber and that higher velocity split effluent stream exhibits greater than a threshold amount of shear mixing as it enters the abatement chamber which improves the destruction rate efficiency.

The method may comprise forming the upstream body of material having at least one of a lower use temperature and lower oxidation resistance than material forming the downstream body

The method may comprise forming the upstream body of material which is chemically compatible with the effluent stream and the downstream body is formed of material which is chemically compatible with abatement byproducts.

The method may comprise providing the inlet nozzle with an obround cross-section.

The method may comprise providing wherein the aperture with an obround cross-section.

The method may comprise locating the aperture located symmetrically within the inlet nozzle.

The method may comprise providing a plurality of the inlet nozzle assemblies and dimensioning each inlet nozzle to have a different length.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 is a cross-sectional view through an abatement apparatus showing inlet assemblies according to embodiments;

FIG. 2(A)-(C) illustrates an inlet assembly in more detail-FIG. 2(A) is a view from upstream of the inlet assembly, FIG. 2(B) is a perspective view and FIG. 2(C) is a view from downstream of the inlet assembly; and

FIG. 3 shows a view from downstream of the combustion chambers.

### DETAILED DESCRIPTION

Before discussing embodiments in any more detail, first an overview will be provided. Embodiments provide an arrangement which enables for different length delivery nozzles to be provided to suit different effluent stream conditions whilst avoiding an unnecessary increase in the inventory of parts required to support different delivery nozzle lengths. Rather than having different height mounts matched to the different length delivery nozzles and/or having different length housings so that abatement chamber enclosures can be located at the correct position for different length delivery nozzles, together with other differently-dimensioned related parts, instead a standard height mount and standard height housing is provided and the different length delivery nozzles protrude at different heights from the mount. In some embodiments, the delivery nozzle is formed of two parts or components. In those embodiments a first, standard-height component of the delivery nozzle fits into the mount and extends into the abatement chamber. A second variable-height part couples with the first part. This means that, in terms of part inventory, irrespective of the length of the delivery nozzle, the housing for the enclosure which defines the abatement chamber, the mount and the first part of the delivery nozzle can all be a standard size and the only component which changes dimension is the second part of the delivery nozzle. This significantly reduces the size of the inventory and the complexity of assembling the abatement apparatus.

### Inlet Assembly

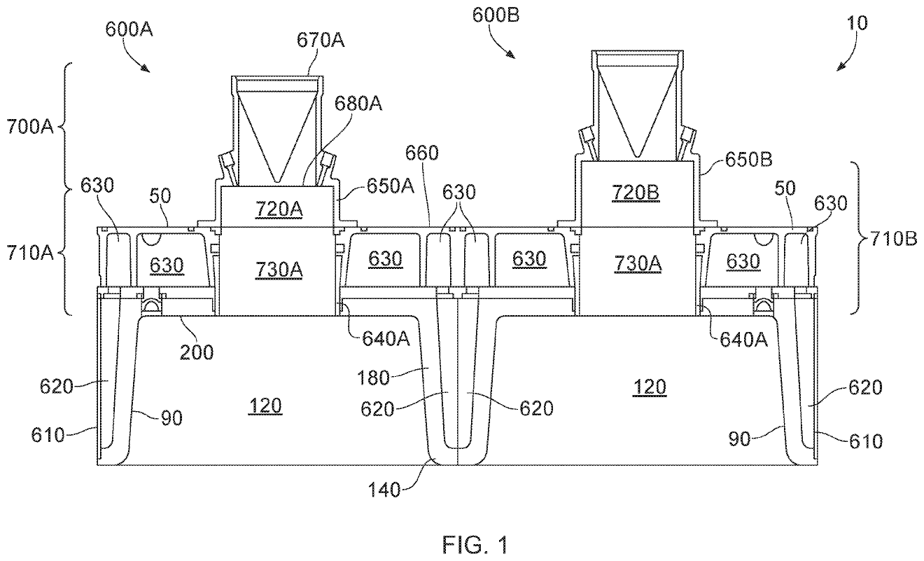

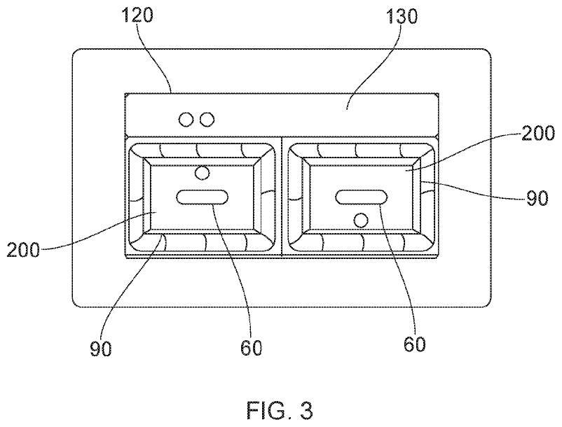

FIG. 1 illustrates inlet assemblies 600A, 600B for an abatement apparatus 10, according to one embodiment. The abatement apparatus 10 comprises a foraminous sleeve 90 which defines a combustion chamber 120. In this example, the foraminous sleeve 90 defines a tapered cuboid combustion chamber 120, as illustrated in FIG. 3 which shows a view from downstream of the combustion chambers 120. The foraminous sleeve 90 has a planar upstream ceiling 200 from which depends four diverging walls 180 which terminate with a rounded shoulder 140 at a discharge end of the combustion chamber 120. This forms a combustion chamber 120 having a generally trapezoidal configuration. A pilot module 20 has a downstream discharge surface 130 which abuts the shoulder 140 of the foraminous sleeves 90. However, it will be appreciated that other shapes and configurations of combustion chambers are possible. Also, although in this embodiment the abatement apparatus is a radiant burner abatement apparatus, it will be appreciated that other types of abatement apparatus are possible having different types of combustion chamber 120. The foraminous sleeve 90 is retained within a housing 610. A plenum 620 is defined between an inwardly-facing surface of the housing 610 and an outwardly-facing surface of the foraminous sleeve 90.

The housing 610 and the foraminous sleeve 90 are retained by a mount 50. In this example, the mount 50 defines a plenum 630 which is in fluid communication with the plenum 620. However, it will be appreciated that other arrangements are possible and that the plenum 630 may be omitted if required. Should that be the case then the height of the mount 50 will be significantly smaller. Both the mount 50 and the ceiling of the foraminous sleeve 90 are provided with an aperture 60 which is shaped to receive a portion of the inlet assembly 600, as will be explained in more detail below.

The inlet assembly 600A comprises a downstream body 640A and an upstream body 650A. The downstream body 640A extends between an upstream surface 660 of the mount 50, through the mount 50 and the ceiling of the foraminous sleeve 90 into the combustion chamber 120. The upstream body 650A extends from the upstream surface 660 of the mount 50 to a coupling inlet 670A which couples with a supply of the effluent stream (not shown).

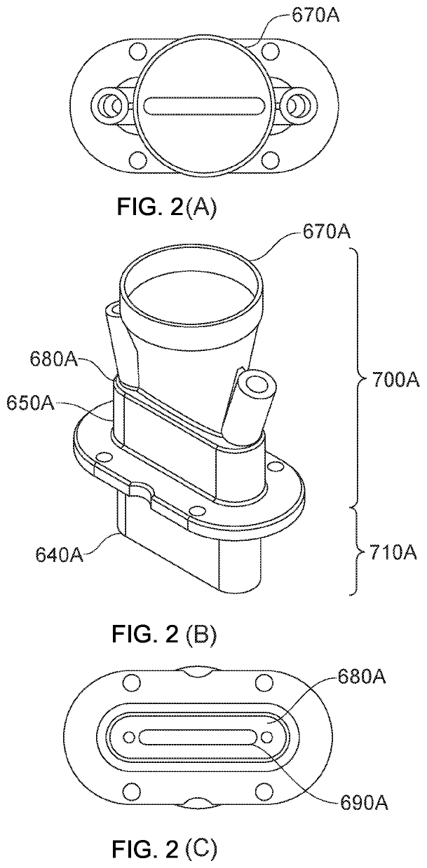

As can best be seen in FIG. 2, the coupling 670A has a circular cross-section to match the shape of the supply of the effluent stream. As such, other shape couplings 670A are possible to suit the shape of the supply. Downstream of the coupling 670A is a dividing plate 680A which defines an aperture 690A.

The upstream body 650A defines an inlet portion 700A which transitions between the circular cross-section at the coupling 670A to an obround cross-section at the dividing plate 680A to match the shape of a delivery chamber 710A. As such, other shapes are possible to suit the shape of the delivery chamber 710A. The upstream body 650A defines a portion 720A of the delivery chamber 710A which extends downstream from the dividing plate 680A. The downstream body 640A provides another portion 730A of that delivery chamber 710A. Providing a separate upstream body 650A and downstream body 640A increases the range of materials from which these bodies can be formed since the conditions which they are subjected to vary between these bodies. In operation, the effluent stream flowing through the aperture 690A creates a pair of vortices which extend downstream of the dividing plate 680A within the delivery chamber 710A. The effluent stream therefore splits into a pair of typically slightly diverging and expanding split-flows which fan out downstream of the dividing plate 680A within the delivery chamber 710A and flow through into the combustion chamber 120. Typically, the overall length of an inlet nozzle assembly is selected to ensure that any vortices are retained within the length of its delivery chamber. As mentioned above, if the vortices were to extend into the combustion chamber 120 then this can result in lower-pressure areas which can cause gases from within the abatement chamber 120 to be drawn back into the delivery nozzle which can result in accumulation of particulates within the delivery nozzle, leading to blockages. The split flows entering the combustion chamber 120 have a higher velocity than would otherwise occur if the effluent stream had not been split by the operation of the dividing plate 680A and that higher velocity split effluent stream thus exhibits greater than a threshold amount of shear mixing as it enters the abatement chamber which improves the destruction rate efficiency. However, it will be appreciated that other flow configurations are possible with other configuration inlet assemblies which may require differing overall lengths.

As can be seen in FIG. 1, the inlet nozzle assembly 600B has a longer overall length than the inlet nozzle assembly 600A, but the additional length is accommodated by providing a longer portion 720B of the delivery chamber 710B provided by the upstream body 650B.

Hence, it can be seen that whatever length of inlet nozzle assembly is required in order to deliver an effluent stream with the required flow characteristics into the combustion chamber 120, this can be achieved without needing to change the dimensions or configuration of either the mount 50, the housing 610, the foraminous sleeve 90 defining the combustion chamber 120 or other related parts. Instead, the different length can be achieved by just changing the length of the inlet assembly and, in embodiments where this is formed from multiple parts, just changing the length of one of those parts and a common downstream body 640A can be used. This simplifies the part inventory for producing and maintaining such abatement apparatus.

Some embodiments provide a construction method for extreme flow (>1000 l/min) nozzles for abatement systems that allows them to be deployed in a “mix and match” fashion with lower flow inlets in an abatement system built on a modular burner architecture. So-called slot nozzles have been demonstrated to give superior abatement performance at high flows compared to conventional circular nozzles. One design, optimised for flows between 200 and 600 l/min comprises a nozzle of obround profile, 16 mm wide on 50 mm centres, 75 mm long. This inlet suits semiconductor chemical vapour deposition processes, especially those with high deposition rates as used in the manufacture of 3-dimensional NOT-AND (3D NAND) memory devices. For yet higher flows, such as seen in the flat panel display industry, an inlet of higher capacity/larger size is required. Computational fluid dynamics analysis predicts equivalent flow behaviour at 1000 to 1200 l/min flow rates to that previously seen (at 300 to 600 l/min in the 50×116×75 mm nozzle) in an obround nozzle of cross section 75×24 mm. It is typically necessary also to increase the length in proportion—from 75 mm to 113 mm in order to house the vortices that form under the slit aperture as the flow develops into the nozzle. This vortex formation and flow splitting has been demonstrated to contribute to the enhanced abatement performance of these high flow inlets. By the constructional technique detailed above, some of the nozzle length is housed in the inlet, giving the required distance from the trailing edge of the slit aperture to the discharge end of the nozzle whilst maintaining a common datum face for the burner mount. By this means, low flow and high flow modules can be deployed together. This provides for maximum flexibility, minimum inventory count when building modular systems. This also allows for configuration and re-configuration of modular systems by changing the minimum number of components.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

The invention claimed is:

1. An inlet nozzle assembly for an abatement apparatus for treating an effluent stream from a semiconductor processing tool, said inlet nozzle assembly comprising:
a delivery nozzle configured to deliver said effluent stream into an abatement chamber; and
a mount configured to couple with an enclosure defining said abatement chamber, said mount being further configured to receive said delivery nozzle for delivery of said effluent stream into said abatement chamber, wherein said delivery nozzle is configured to extend from said mount distal from said abatement chamber.

2. The inlet nozzle assembly of claim 1, wherein said delivery nozzle is dimensioned to extend from a surface of said mount distal from said abatement chamber.

3. The inlet nozzle assembly of claim 2, wherein said delivery nozzle is dimensioned to upstand from said surface of said mount.

4. The inlet nozzle assembly of claim 1, wherein said mount has a downstream surface which couples with said enclosure defining said abatement chamber and an upstream surface from which said delivery nozzle extends.

5. The inlet nozzle assembly of claim 1, wherein said delivery nozzle comprises an upstream inlet portion defining an inlet chamber for receiving said effluent stream and a downstream delivery portion defining a delivery chamber for delivery of said effluent stream into said abatement chamber, wherein at least a part of said delivery portion is dimensioned to extend from said mount.

6. The inlet nozzle assembly of claim 4, wherein at least a part of said delivery portion is dimensioned to upstand from said upstream surface.

7. The inlet nozzle assembly of claim 5, wherein said mount is configured to receive at least a portion of a remainder of said delivery portion therewithin.

8. The inlet nozzle assembly of claim 5, wherein said delivery portion is dimensioned to extend from upstream of said upstream surface to said abatement chamber.

9. The inlet nozzle assembly of claim 5, wherein said delivery nozzle comprises a dividing plate defining an aperture which couples said inlet chamber with said delivery chamber and said delivery nozzle is dimensioned to locate said dividing plate upstream of said upstream surface of said mount.

10. The inlet nozzle assembly of claim 5, wherein said delivery nozzle comprises an upstream body comprising said inlet portion and said at least a part of said delivery portion and a downstream body comprising a remainder of said delivery portion.

11. The inlet nozzle assembly of claim 10, wherein said downstream body is dimensioned to extend from said upstream surface, through said mount and said enclosure to said abatement chamber.

12. The inlet nozzle assembly of claim 10, wherein said upstream body is dimensioned to provide one of a plurality of different lengths of said at least a part of said delivery portion.

13. The inlet nozzle assembly of claim 10, wherein said upstream body is dimensioned to provide a length of said delivery portion which delivers a selected flow profile of said effluent stream into said abatement chamber.

14. The inlet nozzle assembly of claim 10, wherein said upstream body is dimensioned to provide a length of said delivery portion which avoids backflow of said effluent stream from said abatement chamber.

15. The inlet nozzle may assembly of claim 10, comprising a discontinuity shaped to separate said effluent stream into a least a pair of vortices and wherein said upstream body is dimensioned to provide a length of said delivery portion which prevents said pair of vortices from extending into said abatement chamber.

16. The inlet nozzle assembly of claim 10, wherein said upstream body is formed of material having at least one of a lower use temperature and a lower oxidation resistance than material forming said downstream body.

17. An abatement apparatus comprising at least one inlet nozzle assembly as claimed in claim 1.

18. The abatement apparatus of claim 17, comprising a plurality of said inlet nozzle assemblies, each having a having a different length.

19. A method comprising:
configuring a delivery nozzle to deliver an effluent stream into an abatement chamber;
coupling a mount with an enclosure defining said abatement chamber; and
receiving said delivery nozzle with said mount, said delivery nozzle extending from said mount distal from said abatement chamber.
